(19) United States
(12) Patent Application Publication
(10) Pub. No.: US 2010/0136255 A1
(43) Pub. Date: Jun. 3, 2010

(54) ICE LAYERS IN CHARGED PARTICLE SYSTEMS AND METHODS

(75) Inventors: John A. Notte, IV, Gloucester, MA (US); Lawrence Scipioni, Bedford, MA (US); Billy W. Ward, Merrimac, MA (US); William B. Thompson, Los Altos, CA (US)

Correspondence Address: FISH & RICHARDSON PC, P.O. BOX 1022, MINNEAPOLIS, MN, 55440-1022, US

(73) Assignee: CARL ZEISS SMT INC., Peabody, MA (US)

(21) Appl. No.: 12/625,912

(22) Filed: Nov. 25, 2009

Related U.S. Application Data
(63) Continuation of application No. PCT/US2008/065470, filed on Jun. 2, 2008.
(60) Provisional application No. 60/942,903, filed on Jun. 8, 2007.

(51) Int. Cl. B05D 3/06; G21K 5/00

(52) U.S. Cl. 427/534; 250/492.3; 427/533; 427/552

(57) ABSTRACT

Charged particle sources, systems and methods are disclosed.

### CROSS-REFERENCE TO RELATED APPLICATIONS

This application is a continuation of, and claims benefit under 35 USC 120 to, international application PCT/US2008/065470, filed Jun. 2, 2008, which claims benefit of U.S. Ser. No. 60/942,903, filed on Jun. 8, 2007. International application PCT/US2008/065470 is hereby incorporated by reference in its entirety.

### TECHNICAL FIELD

The disclosure relates to charged particle sources, systems and methods.

### BACKGROUND

Charged particles such as ions can be formed using, for example, a liquid metal ion source or a gas field ion source. In some instances, charged particles such as ions formed by an ion source can be used to determine certain properties of a sample that is exposed to the charged particles, or to modify the sample. In other instances, charged particles such as ions formed by an ion source can be used to determine certain characteristics of the charged particle source itself.

### SUMMARY

Disclosed herein are methods and systems that include frozen water (e.g., ice) in one or more crystalline and/or amorphous forms for in-situ sample handling and preparation (e.g., semiconductor samples such as wafers, and biological samples), sample inspection, and patterning and repair/reconstruction of samples. In general, layers of ice having controlled thicknesses can be used together with charged particle systems to extend the functionality of the systems. In particular, one or more layers of ice can be used with charged particle sources to produce controlled patterns on a sample by selective addition or removal of material to the sample. Layers of ice can also be used, either with or without charged particle systems, in a variety of sample handling applications. In particular, the physical properties of ice layers can be altered by exposure to a charged particle beam from a charged particle source and/or by controlling other environmental parameters (e.g., temperature of the ice layers) to change and/or apply controlled forces to specific sample regions. Biological samples typically include significant quantities of water (e.g., cytoplasm in cells), and the internal water can be frozen and its properties controlled using charged particle beams and/or environmental controls to realize selective and non-destructive sample manipulation.

The systems and methods disclosed herein are discussed with reference to ion sources and systems, such as helium ion sources and systems. However, in general, the systems can include other types of charged particle sources (e.g., electron sources) in addition to, or as an alternative to, ion sources. Similarly, in general, the methods disclosed herein can be implemented with other charged particle systems in addition to, or as an alternative to, ion systems.

Embodiments can include one or more of the following advantages.

Ice can be used to form inexpensive and easy to use protective layers and/or patterning layers that can be applied in-situ to samples in a vacuum chamber. Ice layers can be reversibly deposited (e.g., via condensation) and removed (e.g., via evaporation, sublimation) and do not leave residues on the sample surface when they are removed. In addition, ice layers can be deposited and removed quickly.

Ice layers can be deposited in a variety of different crystalline forms, in amorphous forms, and with different grain orientations. These crystal forms and grain orientations can be selectively changed to form patterns in the ice layers.

Ice layers typically have a relatively high sputtering yield. As a result, relatively high aspect ratio structures can be formed in ice layers via sputtering and/or sublimation by exposure to an incident ion beam.

Ice layers are typically relatively non-reactive chemically with a wide variety of samples. As a result, ice layers can be deposited and removed without inducing permanent changes to the sample structure.

Physical properties of ice layers can be readily modified by adjusting various environmental conditions. For example, expansion of ice layers can be controlled by adjusting the layer temperature. Forces can be applied to a sample via ice layer expansion to cause delamination of layers applied to the sample, or other types of sample movement.

The details of one or more embodiments are set forth in the accompanying description and drawings below. Various features and advantages will be apparent from the description and drawings.

### DESCRIPTION OF DRAWINGS

FIGS. 1A and 1B are schematic diagrams showing patterning of an ice layer by exposing the ice layer to an ion beam.

FIG. 2 is a schematic diagram showing conversion of portions of an ice layer from an amorphous structure to a crystalline structure.

FIG. 3 is a schematic diagram showing selective removal of portions of an ice layer by exposure to an ion beam.

FIG. 4 is a schematic diagram showing selective deposition of regions of ice having different thicknesses on the surface of a sample.

FIGS. 5A-C are schematic diagrams showing patterning of an ice layer by exposing the ice layer to an ion beam in the presence of water vapor.

FIGS. 6A and 6B are schematic diagrams showing selective removal of a sample layer by patterning an underlying layer of ice.

FIG. 7 is a schematic diagram showing an ice layer that includes high aspect ratio features.

FIGS. 8A and 8B are schematic diagrams showing implantation of dopants into a sample by transferring the dopants from an ice layer.

FIGS. 9A and 9B are schematic diagrams showing exposure of a sensitive film of material to an ion beam through an ice layer.

FIG. 10 is a schematic diagram showing exposure of an ice layer on a sample to an ion beam and to water vapor to reduce surface charge on the sample surface.

FIG. 11 is a schematic diagram showing exposure of a frozen biological sample to an ion beam to form a locally aqueous environment for a portion of the sample.

FIG. 12 is a schematic diagram showing layers of ice that are used to assist in separating a thin lamella from a sample.

FIGS. 13A and 13B are schematic diagrams showing an ice layer that is used to separate a thin film from a sample.

FIGS. 14A and 14B are schematic diagrams showing an ice layer that forms between a cooled needle and a thin lamella and is used to assist in separating the lamella from a sample.

FIG. 15 is a schematic diagram showing a sample that includes a plurality of defect sites which act as nucleation sites for the formation of ice crystals.

FIGS. 16A and 16B are schematic diagrams showing an ice layer that is used to remove contaminants from the surface of a sample.

FIG. 17 is a schematic diagram showing a contaminant on the surface of a sample that is immobilized by an ice layer.

FIGS. 18A and 18B are schematic diagrams showing an ice layer that is used to form a mold of a sample surface.

FIG. 19 is a schematic diagram of an ion microscope system.

FIG. 20 is a schematic diagram of a gas field ion source.

Like reference symbols in the various drawings indicate like elements.

### DETAILED DESCRIPTION

Each of the following applications is incorporated by reference herein in its entirety: U.S. application Ser. No. 11/600,711, filed Nov. 15, 2006, now published as U.S. Patent Application Publication No. US 2007/0158558; and U.S. application Ser. No. 11/688,602, filed Mar. 20, 2007, now published as U.S. Patent Application Publication No. US 2007/0227883.

### Sample Modification and Patterning

As discussed above, one or more layers of ice can be deposited on one or more surfaces of a sample in an ion system. The one or more ice layers can be crystalline ice layers, amorphous ice layers, or mixtures of amorphous and crystalline ice. Crystalline ice layers formed on sample surfaces can adopt one or more of a variety of different crystal structures.

In some embodiments, a crystalline layer of ice can be deposited on a surface of a sample and the ion beam can be directed to the ice layer. Where the ion beam impinges on the ice layer, the ice is locally converted to an amorphous (e.g., non-crystalline) form. This technique can be used to create two-dimensional patterns in the ice layer. If the amorphous and crystalline ice have different molar volumes, for example, three-dimensional patterns can be created. The created patterns can typically have feature sizes that are comparable to the size of the beam at its focus. Without wishing to be bound by theory, it is believed that transitions between crystalline and amorphous ice can be induced by local heating effects due to the impinging ion beam and/or other forms of energy transfer to the ice lattice that induce transitions between thermodynamic states (e.g., from a higher energy state to a lower energy state, or from a lower energy state to a metastable higher energy state).

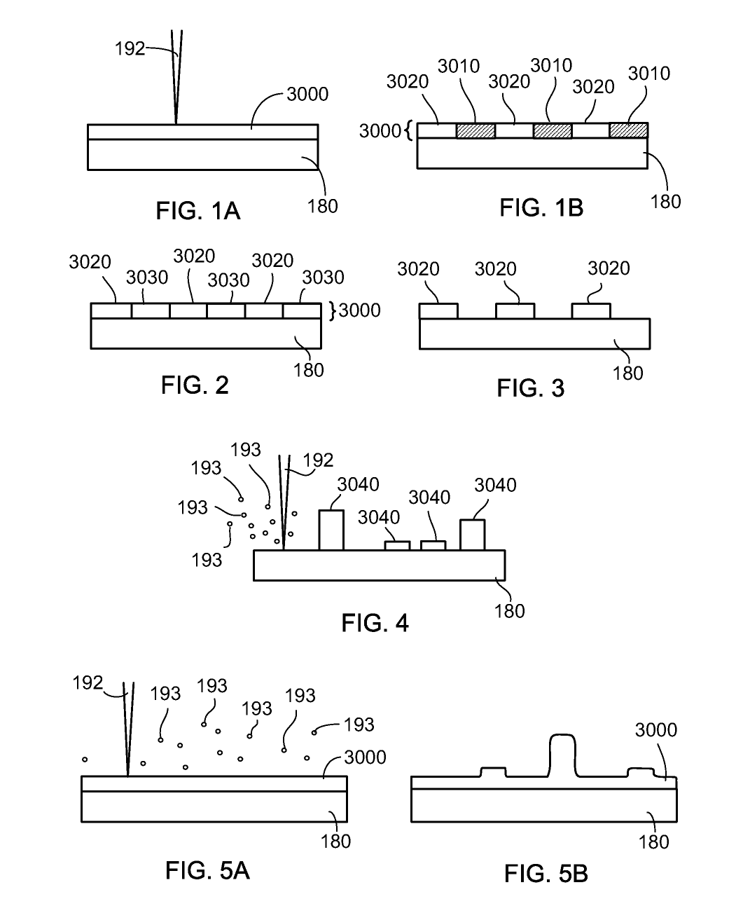

FIG. 1A shows a sample 180 that includes an ice layer 3000 deposited on the sample. Ice layer 3000 is selectively exposed to an ion beam 192 to create a patterned ice layer. FIG. 1B shows an exemplary patterned ice layer that results from exposure to ion beam 192. The patterned ice layer includes regions 3020 that correspond to the original structure of ice layer 3000 (e.g., crystalline ice), and regions 3010 that correspond to amorphous ice, and which are produced by exposure to ion beam 192.

In certain embodiments, the reverse process can be performed by exposing deposited ice layers to the ion beam. That is, deposited ice layers that include regions of amorphous ice can be converted to regions of crystalline ice. By controlling parameters of the ion beam (e.g., ion energy, incident angle) and environmental conditions (e.g., temperature, pressure), the amorphous ice can be converted to a selected crystalline form. As discussed above, this technique can be used to pattern the ice layer(s). The patterned ice layers can subsequently be used in various process steps to create patterned sample surfaces, for example.

FIG. 2 shows the patterned ice layer of FIG. 1B after exposing the ice layer a second time to ion beam 192, where ion beam 192 is configured to convert amorphous regions 3010 to regions of crystalline ice. As shown in FIG. 2, the resulting ice layer includes regions 3020 that correspond to the original structure of ice layer 3000, and regions 3030 that correspond to crystalline ice. The crystalline regions 3030 can have the same crystalline structure as regions 3020, or regions 3030 can have crystalline structures that are different from the crystalline structures of regions 3020.

In some embodiments, exposure of one or more ice layers to the ion beam can be used to change the crystalline form (e.g., the crystal phase) and/or grain orientation in the ice layers. For example, the ion beam can be used to create two- and/or three-dimensional patterns in the ice layers by converting portions of the layers from a first crystalline form to a second crystalline form. Alternatively, or in addition, by inducing local melting (and allowing subsequent re-freezing) of the ice in the region where the ion beam impinges, ice grain orientations can be selectively changed. Grain orientation changes can also be selectively applied to form patterns in the ice layers.

In certain embodiments, additional physical steps can be applied to ice layers that include patterns of different ice forms (e.g., different crystalline phases and/or amorphous regions) and patterns of different grain orientations. The additional steps can include steps that are selective for certain phases and/or grain orientations, and/or steps that have different effects on the different phases/amorphous regions/grain orientations. By employing these selective steps, further patterning of the ice layers can be induced. As an example, material can be selectively removed (e.g., via ion beam etching or chemical etching) from one phase/amorphous region/grain orientation, leaving the others intact, thereby further patterning the ice layer. FIG. 3 shows the patterned ice layer of FIG. 1B, after either ion beam etching or chemical etching have been used to selectively remove regions 3010, leaving only regions 3020 of ice layer 3000 on sample 180.

In some embodiments, the ion beam can be used to induce selective ice layer growth under controlled conditions. For example, by cooling the sample surface and introducing water into the sample chamber under conditions where the water molecules (e.g., water vapor) are near their thermodynamic triple point (e.g., where water can exist as a solid, liquid, or gas), the ion beam can be directed to impinge on selective regions of the sample surface. In regions where the ion beam impinges, the ion beam interacts with water vapor in the vicinity of the sample surface to cause condensation and deposition of ice on the sample surface. Control over the position and size of the ion beam permits selective patterning of the sample surface with deposited regions of ice. As discussed above, by adjusting various ion beam and environmental parameters, the phase and/or grain orientation of the deposited ice can be controlled either during deposition or in a subsequent exposure step following deposition.

FIG. 4 shows a sample 180 which is exposed to ion beam 192 in the presence of water molecules 193. Interactions between ion beam 192 and water molecules 193 lead to the deposition of ice on the surface of sample 180. By controlling, for example, the position of ion beam 192 on the surface of sample 180 and the duration of exposure of various regions of sample 180 to ion beam 192, regions of ice 3040 that are selectively positioned on sample 180 and which have controlled thicknesses can be deposited.

In certain embodiments, ice growth can be induced by exposure of super-cooled water to the ion beam. In analogy to the discussion above, a water layer is deposited onto the sample surface and then brought into a super-cooled state, and exposure of the sample to the ion beam in the presence of super-cooled water selectively deposits regions of ice on the surface of the sample.

Solid-gas water equilibria can also be used to pattern ice layers on sample surfaces. For example, in some embodiments, a sample with one or more ice layers can be exposed to water vapor to create an equilibrium between the solid ice layers and the water vapor. Selective exposure of the sample to the ion beam can be used to disrupt the equilibrium. Disruption of the equilibrium leads to either deposition of further ice on the surface of the sample (e.g., thickening) or evaporation of ice from the surface of the sample (e.g., thinning) These processes, which can be selectively controlled via adjustable ion beam properties (e.g., to select between evaporation and deposition, and rates of these processes) occur only locally, in the region of the sample exposed by the ion beam. As a result, surface patterns with dimensions on the same order as the size of the focal region of the ion beam can be created. The pattern surface can be further used, for example, as a surface for patterned growth of materials of interest such as further deposition layers.

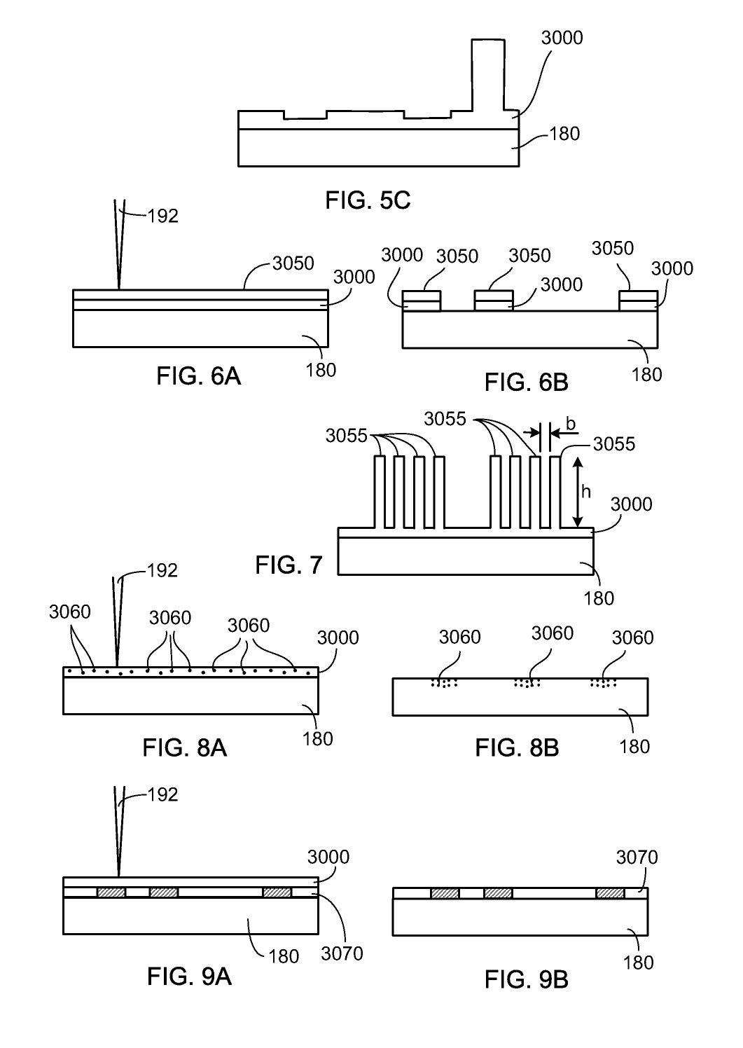

FIG. 5A shows a sample 180 that includes an ice layer 3000 in equilibrium with water molecules 193 in a vapor phase above the ice layer. By selectively exposing ice layer 3000 to ion beam 192 while layer 3000 is in equilibrium with water vapor, ice layer 3000 can be patterned as shown in FIG. 5B. FIG. 5C shows another example of patterning ice layer 3000 by exposure to ion beam 192 while layer 3000 is in equilibrium with water vapor. As illustrated in FIG. 5C, ice layer 3000 can be selectively thinned, thickened, or both thinned and thickened, by exposure to ion beam 192 under appropriate conditions.

In certain embodiments, ice layers on sample surfaces can be patterned via sublimation rather than via sputtering when exposed to the incident ion beam. For example, the properties (e.g., incident ion energy, incident angle) of the ion beam can be adjusted so that sputtering of the ice layers is not significant. However, by selecting appropriate environmental conditions, the energy supplied to ice molecules can be sufficient to cause sublimation of the ice molecules. Well-controlled patterns in the ice layer surfaces can be created, the edge- and line-widths of which can be sharper than edge- and line-widths created via sputtering.

Sublimation can also be used to selectively remove ice from a mixture of layer materials. For example, where a plurality of layer materials including ice are used to form one or more layers on a sample surface (e.g., a first layer of ice, which can be patterned, followed by a layer of another material), sublimation can be induced by exposure to the ion beam as discussed above to selectively remove portions (or all) of the ice layer, leaving the other material unaltered. Portions of the other layer which are no longer supported by an ice layer can be selectively removed, for example. FIG. 6A shows a sample 180 that includes an ice layer 3000 and another layer of material 3050 that is deposited on ice layer 3000. By exposing ice layer 3000 to ion beam 192, selected portions of ice layer 3000 can be removed. Corresponding portions of layer 3050 which are no longer supported by ice layer 3000 can also be removed, as shown in FIG. 6B.

In certain embodiments, ice layers can be milled (e.g., via sublimation or sputtering) by exposure to the ion beam, and a milling rate of the ice layers can be selectively controlled by adjusting the temperature of the ice layers. For example, as the temperature of the ice layers is increased, the milling rate is faster because the ion beam has to supply a smaller amount of heat to the ice to induce sublimation and/or sputtering.

In some embodiments, grain orientations of ice in different regions of an ice layer can be adjusted to selectively control depth of penetration of incident ions into the sample. The ease of penetration of the ions through the ice layer is related to the ion channeling effect. That is, where ice grains are favorably oriented, incident ions can pass through the ice grains with little to no loss of incident energy, and penetrate deeply into the underlying sample. With an unfavorable orientation of the grains (e.g., with channels orthogonal to an incident direction of the ions), the incident ions will not penetrate the ice layer to reach the underlying sample, or may reach the underlying sample having lost significant quantities of energy to collisions in the ice layer. As a result, the penetration depth of such ions into the sample is relatively small. As discussed previously, grain orientations in the ice layer can be selectively controlled, permitting high-resolution patterning/modification of the sample by using the ice layer(s) as a mask. The incident ion beam used to pattern the underlying sample does not necessarily have to be a high resolution beam (e.g., small spatial cross-section) and does not have to be focused onto the surface of the sample, because the spatial exposure pattern and its resolution on the sample surface is controlled by the ice masking layer.

Typically, the greater penetration of helium ions in ice layers (as opposed to heavier ions such as gallium) provides a smaller patterning resolution when ice layers are exposed to incident ions in the ion beam. Helium ions with parallel trajectories typically propagate further into ice layers before the trajectories begin to substantially diverge; the thickness of the ice layer can be selected so that most of the spatial broadening of the helium ion beam occurs after the helium ions have passed through the ice layer.

In some embodiments, milling rates of ice layers can be dependent upon grain orientation. As discussed above, grain orientations in the layers can be selectively controlled/patterned so that ion milling of the ice layers produces three-dimensional surface structures (e.g., surface relief structures). Grain boundaries can be also be selectively modified via incident ions (e.g., to control local thermodynamic conditions in the ice layers) to induce controlled variations in grain sizes and/or orientations. The sizes and/or orientations can be produced in selected patterns, and the patterned ice layers can be employed in further processing steps.

Rates of sputtering and/or sublimation can be controlled by adjusting the incident ion beam focusing properties. Typically, sputtering rates are dependent on a total dose of incident ions, while sublimation rates depend on local energy density and thermal conductivity. For example, in some embodiments, to favor sublimation over sputtering for removal of water molecules from an ice layer, the ion beam can be focused to a smaller spot size. Other ion beam parameters, such as dwell time, frame rate, duty cycle, and pixel separation, can also be adjusted to vary the ratio of sputtering rate to sublimation rate.

Ice has a relatively high sputtering yield in comparison to many semiconductor materials, and the sputtering yield of ice can be increased by increasing the temperature of the ice layer. As a result, patterning ice layers using the methods disclosed herein can be used to create very high aspect ratio features in the patterned ice layers. The incident ion beam typically penetrates deeply into the ice layers and ejects many water molecules (or fragments thereof) during exposure. As a result, high aspect ratio surface relief features can be produced after relatively short exposure times.

FIG. 7 shows a sample 180 that includes an ice layer 3000 in which a plurality of high aspect ratio features 3055 have been formed. Each feature has a maximum dimension b measured in a plane parallel to the surface of sample 180, and a maximum dimension h measured along a direction normal to the surface of sample 180. In some embodiments, for example, a ratio of h/b can be 2 or more (e.g., 3 or more, 4 or more, 5 or more, 10 or more, 20 or more, 30 or more, 50 or more, 100 or more, 200 or more, 300 or more, 500 or more, or even more).

Other materials can be introduced into the ice layers for subsequent implantation into the underlying sample. For example, various dopant gases can be introduced into the sample chamber during formation of the ice layer(s), and can be condensed in the deposited ice layers on the sample surface. When the ice layers are exposed to the incident ion beam, incident ions collide with the dopant atoms/molecules (e.g., As, P) in the ice layer, driving the dopant atoms/molecules into the sample via momentum transfer. Following removal of the ice layer(s), the bare sample includes a region near the surface that is patterned via implanted dopants. In certain embodiments, metal-baring gases can be included in the ice layer(s) and can be deposited via incident ion collisions onto the surface of the sample to form surface metal (conducting) regions. The deposition can be performed with the high spatial resolution of the ion beam. In some embodiments, seed materials for the formation of carbon nanotubes can be implanted into the sample via collision-transfer from the ice layer(s). Seed materials typically include, for example, cobalt, nickel, and iron. High-resolution positioning of these seed materials at the surface of the sample can be achieved via exposure of an ice layer containing these materials to the ion beam.

FIG. 8A shows a sample 180 and an ice layer 3000 deposited on the sample. Ice layer 3000 includes a plurality of dopant particles 3060. By exposing ice layer 3000 to ion beam 192, dopant particles 3060 can be transferred from ice layer 3000 to sample 180. By selectively exposing only certain regions of ice layer 3000, dopant particles 3060 can be transferred to sample 180 to form patterns in the sample. An exemplary patterned dopant transfer to sample 180 is shown in FIG. 8B after removal of ice layer 3000.

Multiple layer deposition techniques can be used to create free standing three-dimensional structures, such as MEMS devices. For example, in some embodiments, materials can be deposited layer-by-layer, and areas that will eventually be empty are filled with deposited ice. Following completion of the deposition sequence, the ice is removed (e.g., via evaporation), leaving behind a three-dimensional structure composed of the other deposition materials.

In some embodiments, ice layers can be used in combination with photoresist materials. For example, certain photoresist materials expose very easily and are quickly damaged during exposure. A hard mask formed of ice can be placed on top of such photoresists and exposed under normal conditions. Following development, a pattern through which a beam can pass is present. As a result, a clean, accurate exposure of the underlying sensitive resist without damage to regions outside the pattern boundaries can be achieved. Hard masks formed of ice can be deposited, patterned, used, and then removed in-situ. Similarly, in certain embodiments, a thin ice film can be placed over a sensitive film of another material that is to be processed. An incident beam (e.g., light, electrons, ions) penetrates through the ice layer to directly write the underlying sensitive film, which is protected by the ice layer. Following beam writing, the ice layer is removed via evaporation, for example.

FIG. 9A shows a sample 180 and a sensitive film 3070 deposited on the sample. A layer of ice 3000 is deposited on film 3070, and then film 3070 is processed by exposure to ion beam 192 through ice layer 3000. Following removal of ice layer 3000, as shown in FIG. 9B, a selectively processed film 3070 remains on sample 180.

In certain embodiments, dimensions of trenches, holes, and other features in ice layers can be reduced by re-introducing small amounts of water vapor in the vicinity of these features. Water molecules condense onto the ice layers. Typically, the newly condensed molecules form a conformal layer, filling in features such as holes and trenches and reducing their dimensions. As a result, holes, trenches, and similar open structures can be formed in a multi-step process so that they have dimensions that are even smaller than the dimensions of the ion beam.

### Sample Handling and Inspection and Ion Beam Metrology

Deposited ice layers and ice regions can also be used for various sample manipulation, inspection, and beam metrology applications. For example, biological samples—which typically include relatively large amounts of water—are frequently destroyed during freezing. Ice crystal formation causes cell walls to burst, destroying the sample. In some embodiments, exposure of the samples to the ion beam during freezing can disrupt ice crystal formation (e.g., as discussed above in connection with amorphization of crystalline ice), preventing sample destruction.

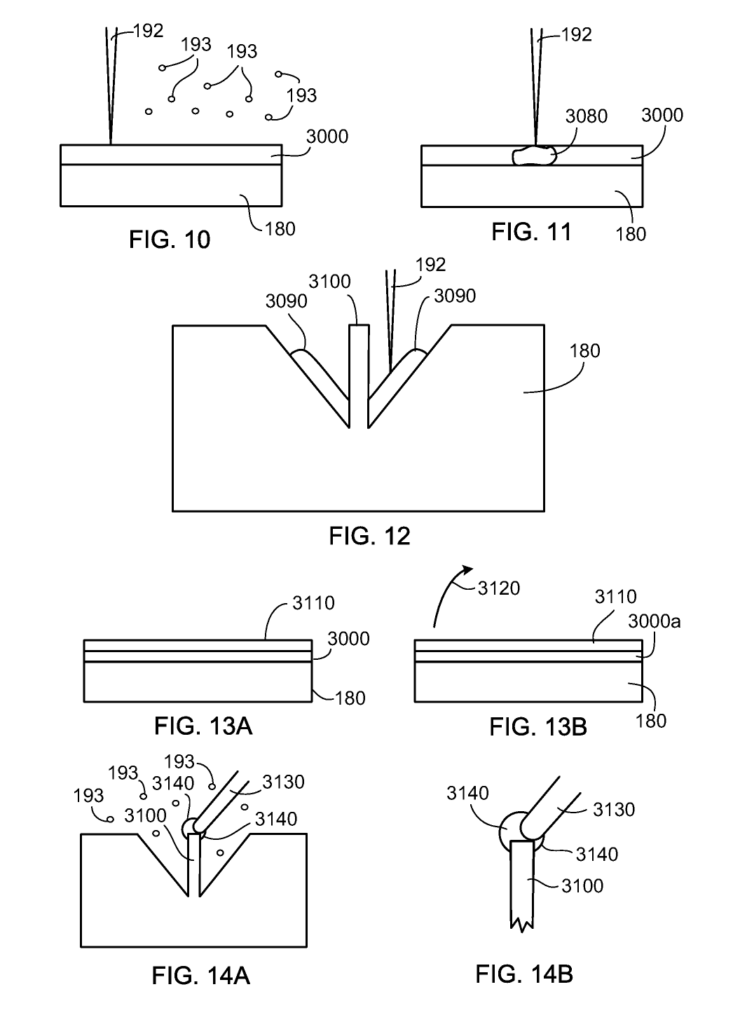

In certain embodiments, an equilibrium between water vapor introduced into the sample chamber and solid ice layers can be induced, as discussed above. Water molecules from the solid ice layers that sublime are replaced by condensing water molecules from the vapor phase. The subliming water molecules carry away excess surface charge from the sample surface. As a result, imaging and patterning processes that employ the ion beam are not disrupted. FIG. 10 shows a sample 180 that includes an ice layer 3000 in equilibrium with water molecules 193. During exposure of sample 180 to ion beam 192, water molecules that sublime from ice layer 3000 carry away surface charge from sample 180. The sublimed water molecules can be replaced by water molecules 193 that condense from the vapor.

In some embodiments, particularly where the sample is a frozen biological sample, controlled small-volume melting via exposure of the frozen sample to the ion beam can be used to create locally aqueous regions. The aqueous regions present imaging conditions that are more representative of in-vivo conditions, while most of the sample is maintained at cryogenic temperatures. Imaging data recorded from the melted small volumes can be more directly applicable to drawing conclusions about in-vivo conditions. FIG. 11 shows a frozen biological sample 180 with a layer of ice 3000 formed on the sample. By exposing sample 180 and ice layer 3000 to ion beam 192, localized aqueous regions 3080 can form in ice layer 3000 due to localized heating of ice layer 3000. The portions of sample 180 in contact with aqueous regions 3080 are in an environment that more closely represents in-vivo conditions than the frozen state of the remainder of sample 180. Imaging data can be collected based on particles that leave aqueous regions 3080 in response to incident ions from ion beam 192, for example.

In certain embodiments, ion beam systems (e.g., helium ion beam systems) can be used to perform depth-resolved imaging, particularly on biological samples. For example, incident ions lose energy via collisions as they penetrate deeper into a sample, and energy loss as a function of depth can either be measured or retrieved from literature. As a result, analysis of the energies of scattered ions can lead to extraction of information about structures at various below-surface depths. Different ice layer thicknesses can be used to control an effective penetration depth or sampling depth of the incident ions, producing depth-dependent information from the sample. By combining the measurement results from different ice layer thicknesses, three-dimensional sample structural data can be obtained.

In some embodiments, the ion beam (e.g., helium ion beam) can be used to preserve the properties of the ice layers during sample processing and handling. For example, helium ions typically do not implant as deeply as heavier ions (e.g., gallium ions), nor do they change thermal and/or electrical properties of the sample. Implanted helium ions diffuse out of the ice layers at relatively high rates, so that there is no permanent change to the properties of the sample or its ice layers. In addition, where properties of the ice layer do change as a result of ion beam exposure or other conditions, the ion beam can be used to repair the ice layer via re-crystallization, grain re-orientation, as discussed above. Similarly, when the sample is a biological sample, implanted helium ions diffuse out of the sample, leaving no residue behind. In contrast, liquid metal ion sources (such as gallium sources) typically deposit significant quantities of metal impurities in biological samples, which would otherwise contain very tiny (or zero) concentrations of metal atoms.

Physical properties of ice layers can also be used for sample manipulation. For example, in some embodiments, small ice layers can be deposited in the vicinity of an attachment point of a thin lamella that will be used as a sample in transmission electron microscopy imaging. Typically, lamella samples rest in triangular grooves that are formed by machining the surface of a sample. By controlling the temperature of the ice layer—and particularly, by forcing expansion of the ice layer by changing the its temperature—the lamella can be pushed out of its groove. Deposition of a small amount of water on the surface of the lamella can also permit easier handling of the otherwise thin, fragile lamella. Placing the lamella on a grid and increasing its temperature causes evaporation of the ice, leaving the lamella in place for imaging without the need for further placement steps.

As an example, FIG. 12 shows a thin lamella 3100 that is formed by milling a triangular channel in a sample 180. An ice layer 3090 is deposited in the channel adjacent to lamella 3100. By controlling the temperature of ice layer 3090 (e.g., either by external heating or cooling, or by exposing ice layer to ion beam 192 as shown in FIG. 12), ice layer 3090 expands, exerting lateral and upward force on lamella 3100 that assists in separating lamella 3100 from sample 180.

Similarly, in certain embodiments, structures can be formed on top of an ice layer (or a liquid water layer). By controlling the temperature of the liquid/solid water layer, expansion of the layer can be induced, causing the structures formed on top of the layer to lift off a substrate underlying the water layer. This technique can be used to lift away extremely thin layers from the surface of a substrate. FIG. 13A shows a sample 180 that includes an ice layer 3000 deposited on the sample, and another layer 3110 deposited on the ice layer. By melting ice layer 3000 to form (fully or partially) liquid water layer 3000a, as shown in FIG. 13B, layer 3110 is no longer firmly secured to sample 180, and can be lifted off from sample 180 in the direction of arrow 3120, for example.

In some embodiments, ice layers/regions can be used as a reversible glue to form attachments between different components. For example, ice regions can be used for lamella lift-out. Following preparation of a lamella in a grooved trench, a cooled needle can be placed in contact with the lamella in the presence of water vapor. Ice forms between the lamella and the cooled needle, adhering the needle to the lamella and permitting lift-out of the lamella from the trench. Once the lamella is out, the needle can be repositioned so that the lamella rests on a sample grid, to which the lamella is fixed (e.g., via welding). The ice between the needle and lamella can then be melted, separating the two, and avoiding the need for cutting methods using, e.g., focused ion beams, for separation. Similarly, a cooled needle can be place in contact with a sample surface in the presence of water vapor to induce local ice formation at the needle position. This method provides an alternative to using a cooled stage, and/or providing complete coverage of a sample surface with an ice layer.

An example of this technique is shown in FIG. 14A, where a thin lamella 3100 is formed in a milled triangular channel of a sample 180. A cooled needle 3130 is positioned to contact lamella 3100 in the presence of water molecules 193. An ice layer 3140 forms in a region surrounding the contact point between needle 3130 and lamella 3100, securing needle 3130 to lamella 3100. By withdrawing needle 3130 and thereby exerting upward force on lamella 3100, the connection between lamella 3100 and the rest of sample 180 can be severed, liberating lamella 3100, as shown in FIG. 14B. Due to ice layer 3140, which secures lamella 3100 to needle 3130, the lamella can be transported to a grid, for example, and/or otherwise handled. Lamella 3100 can be detached from needle 3130 by removing ice layer 3140, e.g., by melting ice layer 3140.

In certain embodiments, one or more ice films can function as heat sinks and/or environmental enclosures when imaging a sample or performing spectroscopic analysis. Enclosures are particularly advantageous for sensitive samples. For example, ice layers can be used to prevent heating and melting cycles of resist materials underlying the ice layers, which would otherwise result from exposure to the ion beam. As another example, when imaging biological samples with electro-luminescent tags, one or more ice layers can be used to protect the sample from heating by dissipating a portion of the energy of the incident ions. Ice layers also provide an optical window for photons to escape from the sample and be detected.

In some embodiments, small regions of ice can be used as flags to find small surface defects on samples such as blank wafers. For example, small defects can be difficult to locate due to limits on the resolution of inspection tools. However, by placing the sample in a cooled environment in the presence of water vapor, defect sites on the sample surface act as nucleation sites for ice crystal growth. The ice crystals can be permitted to grow until their positions are easily identified in an inspection system. The inspection system can record the approximate position of the defects for further review following removal of the ice crystals.

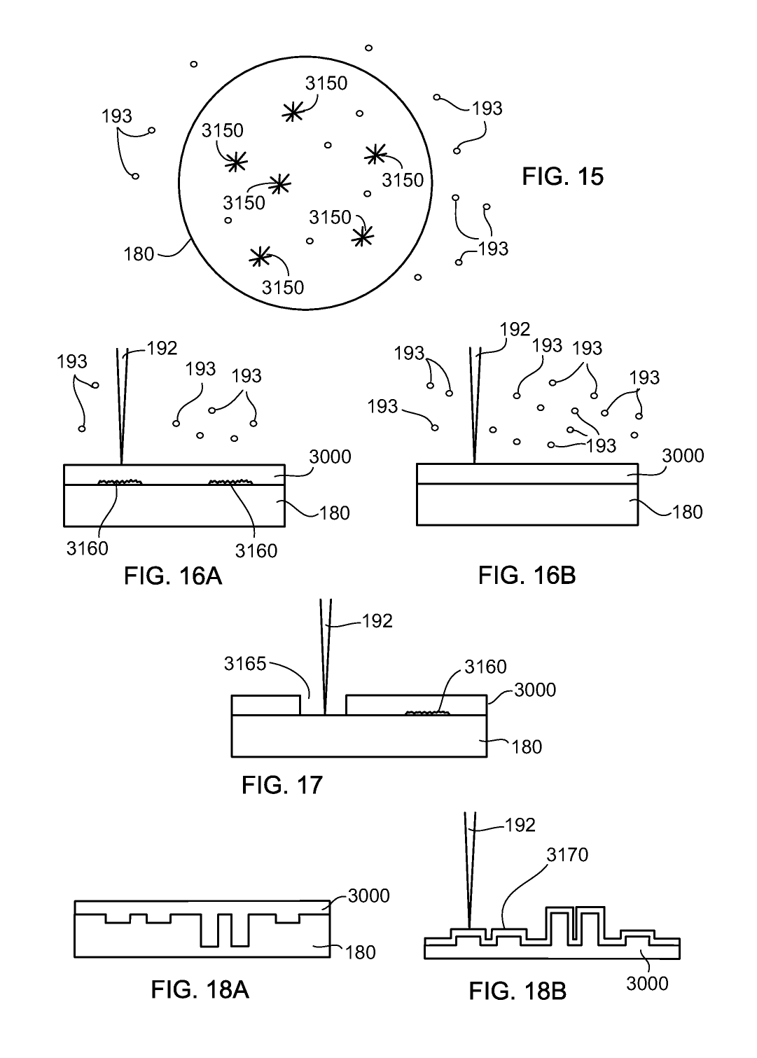

FIG. 15 shows a sample 180 that includes a plurality of defect sites. Sample 180 is cooled and exposed to gas phase water molecules 193. The defect sites on sample 180 act as nucleation sites for ice crystal formation, and water molecules 193 condense from vapor and initiate growth of ice crystals 3150 at various defect sites. By obtaining one or more images of ice crystals 3150 on sample 180, the positions of the defect sites can be recorded for further inspection and/or review following removal of ice crystals 3150.

In certain embodiments, ice regions/layers can be used to remove contaminants from a sample surface. For example, a sample such as a semiconductor wafer having an ice layer can be exposed to water vapor under conditions such that the water vapor is near is thermodynamic triple point. One or more chemical reactions between contaminants and the ice layer can cause water molecules from the ice layer to carry away the contaminants from the sample via evaporation. The evaporated water molecules are replaced by condensing water molecules from the vapor phase to replenish the ice layer. In some embodiments, the products of the one or more chemical reactions can be pumped away mechanically from the ice layer.

For example, FIG. 16A shows a sample 180 that includes surface contaminants 3160 and a layer of ice 3000 formed on the sample. One or more chemical reactions occur between ice layer 3000 and contaminants 3160. Exposure of ice layer 3000 by ion beam 192 leads to evaporation of some of the water molecules in ice layer 3000; concurrently, reaction products that result from reactions between ice layer 3000 and contaminants 3160 are also evaporated from ice layer 3000. Water molecules 193 condense to replace evaporated molecules from ice layer 3000. As a result, as shown in FIG. 16B, surface contaminants 3160 are effectively removed from sample 180 and ice layer 3000 is purified.

Similarly, in certain embodiments, an ice layer can be used to displace contaminants from the surface of the sample. Initially, a liquid water layer is introduced onto the sample surface via condensation from water vapor in the vicinity of the sample. By cooling the sample, the liquid water layer is frozen to form an ice layer. During freezing, ice—which is strongly polar—has a higher bonding affinity for the sample surface than many contaminant molecules (e.g., hydrocarbons) and as a result, the lower-affinity contaminant molecules are displaced from the sample surface when the ice layer is formed via expansion of the ice layer during freezing. The contaminants, dislodged from the sample surface, are then more easily removed via mechanical pumping, chemical washing, or other methods.

Ice layers can also be used to immobilize contaminants on sample surfaces. For example, in some embodiments, a liquid water layer can be introduced onto a sample surface, as discussed above, and then frozen to secure surface contaminants in place on the sample. Subsequently, a window can be opened in the ice layer (e.g., via sputtering and/or sublimation by the ion beam) and investigation of the portion of the sample exposed by the window can be undertaken without interference from contaminants on other portions of the sample surface. As an example, FIG. 17 shows a sample 180 with an ice layer 3000 deposited on the sample to secure a contaminant 3160 to the surface of sample 180. Ice layer 3000 includes a window 3165 that permits exposure of sample 180 to ion beam 192 without interference from contaminant 3160, for example.

In biological samples, ice regions/layers can be used to immobilize large molecules such as DNA, RNA, and proteins. For example, in certain embodiments, ice regions/layers can be used to pin down biological molecules so that they can be imaged or otherwise probed without moving under the influence of beam exposure (e.g., exposure to an ion beam). Molecules can be selectively pinned down in a variety of geometries. For example, the perimeter, the ends, or the entire surface of the molecule can be secured to a support using regions of ice as reversible adhesives.

Ice layers can also be used in cross-sectional metrology of non-planar surfaces. Typically, for example, non-planar surface metrology is initiated by depositing a surface layer using a focused ion beam (FIB) to provide a flat cross-section, and to provide stronger edge contrast in the vicinity of the feature to be imaged. In some embodiments, rather than depositing a layer using a FIB, which can harm the sample, an ice layer is deposited instead. Deposition of the ice layer is rapid, and can be selectively controlled so that ice is deposited only where required for imaging purposes. Following production of cross-sections, the ice layer can be evaporated, leaving behind no residue to harm neighboring functional devices on the sample.

In certain embodiments, ice layers can be used to construct three-dimensional molds of sample surfaces. For example, conformal deposition of an amorphous ice layer over a patterned sample can form a negative replica of the sample surface. Once removed, the ice layer can be coated with a conductive layer. The conductive layer can then be readily investigated to determine various geometrical parameters related to the sample surface. This technique is particularly useful for sensitive materials such as certain resist materials, where direct imaging of the resist causes damage and distorts the shape of the resist.

FIG. 18A shows a sample 180 with a patterned surface. A conformal layer of ice 3000 is deposited on the surface of sample 180, and the ice layer assumes a profile which is complementary to the surface profile of sample 180. By removing ice layer 3000 from sample 180, as shown in FIG. 18B, a mold of the surface of sample 180 is created. Ice layer 3000 can be coated with a layer of conductive material 3170, and then imaged to investigate the geometrical properties of the surface of sample 180.

In some embodiments, ice layers can be used for ion beam metrology. For example, a layer of ice can be exposed to an ion beam to cause milling of the ice layer by the incident ions. The milled region of the ice layer has a cross-sectional shape that closely matches the cross-sectional shape of the ion beam. Subsequently, for example, a layer of conductive material (e.g., metal) can be deposited over the milled ice layer, and the dimensions of the milled region can be measured. This provides a convenient method for measuring a spot size and shape of the ion beam system.

### Formation of Ice Layers

Ice layers can generally be formed on surfaces of samples using a variety of techniques. Typically, for example, an ice layer can be formed by cooling the sample and introducing water vapor in the vicinity of the sample surface. By controlling the environmental conditions within the chamber, deposition properties can be controlled. For example, by adjusting local temperature and pressure, the water vapor can be maintained near its triple point. Alternatively, the water vapor can be maintained so that liquid water condenses from vapor onto the sample surface, or so that gaseous and solid water are in equilibrium (with no intervening water phase) in the vicinity of the sample surface. Other methods of ice layer/region formation, such as localized formation of ice regions rather than a layers extending over an entire surface of the sample, are discussed above.

### Ion Beam Systems

This section discloses systems and methods for producing ion beams, and detecting particles including secondary electrons that leave a sample of interest due to exposure of the sample to an ion beam. The systems and methods can be used to obtain one or more images of the sample.

Typically, gas ion beams that are used to interrogate samples are produced in multipurpose microscope systems. Microscope systems that use a gas field ion source to generate ions that can be used in sample analysis (e.g., imaging) are referred to as gas field ion microscopes. A gas field ion source is a device that includes an electrically conductive tip (typically having an apex with 10 or fewer atoms) that can be used to ionize neutral gas species to generate ions (e.g., in the form of an ion beam) by bringing the neutral gas species into the vicinity of the electrically conductive tip (e.g., within a distance of about four to five angstroms) while applying a high positive potential (e.g., one kV or more relative to the extractor (see discussion below)) to the apex of the electrically conductive tip.

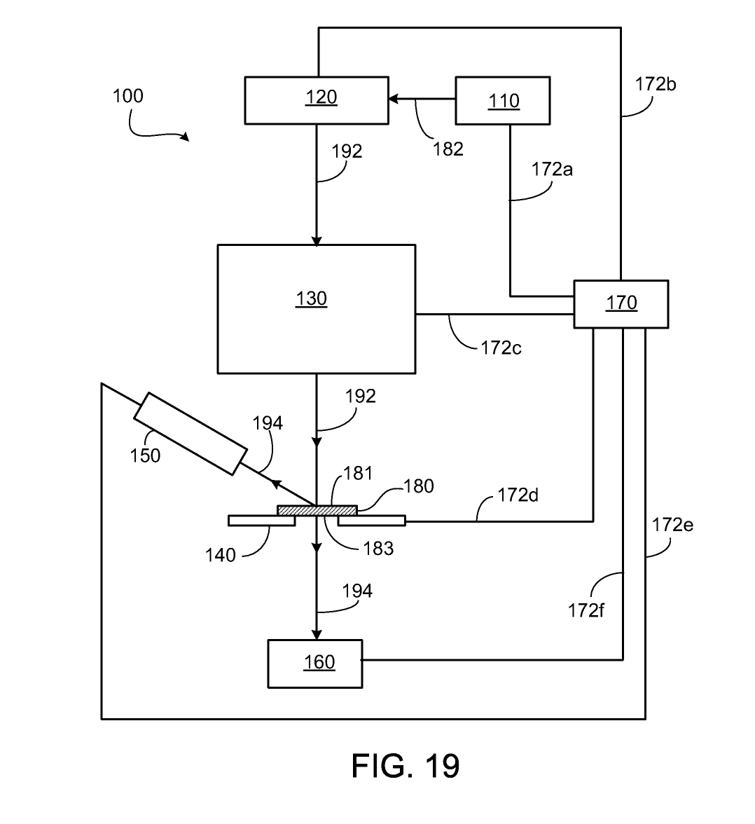

FIG. 19 shows a schematic diagram of a gas field ion microscope system 100 that includes a gas source 110, a gas field ion source 120, ion optics 130, a sample manipulator 140, a front-side detector 150, a back-side detector 160, and an electronic control system 170 (e.g., an electronic processor, such as a computer) electrically connected to various components of system 100 via communication lines 172a-172f. A sample 180 is positioned in/on sample manipulator 140 between ion optics 130 and detectors 150, 160. During use, an ion beam 192 is directed through ion optics 130 to a surface 181 of sample 180, and particles 194 resulting from the interaction of ion beam 192 with sample 180 are measured by detectors 150 and/or 160.

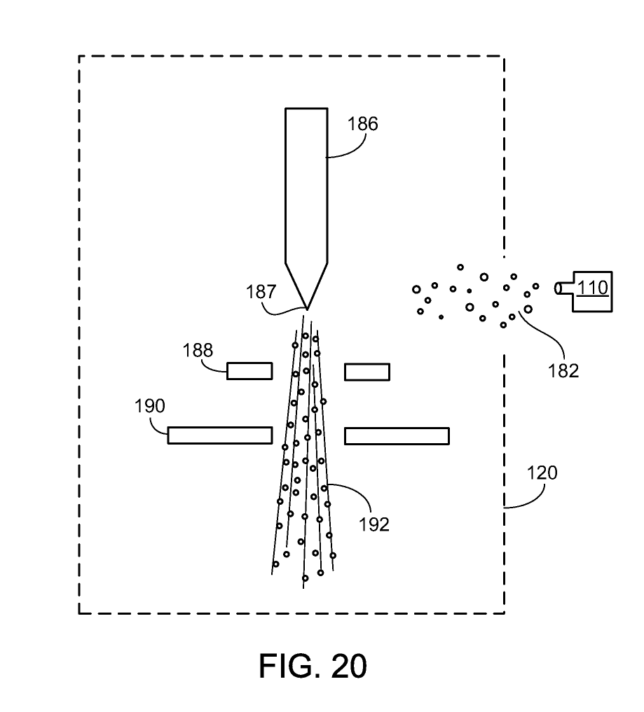

As shown in FIG. 20, gas source 110 is configured to supply one or more gases 182 to gas field ion source 120. Gas source 110 can be configured to supply the gas(es) at a variety of purities, flow rates, pressures, and temperatures. In general, at least one of the gases supplied by gas source 110 is a noble gas (helium (He), neon (Ne), argon (Ar), krypton (Kr), xenon (Xe)), and ions of the noble gas are desirably the primary constituent in ion beam 192.

Optionally, gas source 110 can supply one or more gases in addition to the noble gas(es); an example of such a gas is nitrogen. Typically, while the additional gas(es) can be present at levels above the level of impurities in the noble gas(es), the additional gas(es) still constitute minority components of the overall gas mixture introduced by gas source 110.

Gas field ion source 120 is configured to receive the one or more gases 182 from gas source 110 and to produce gas ions from gas(es) 182. Gas field ion source 120 includes an electrically conductive tip 186 with a tip apex 187, an extractor 190 and optionally a suppressor 188.

Electrically conductive tip 186 can be formed of various materials. In some embodiments, tip 186 is formed of a metal (e.g., tungsten (W), tantalum (Ta), iridium (Ir), rhenium (Rh), niobium (Nb), platinum (Pt), molybdenum (Mo)). In certain embodiments, electrically conductive tip 186 can be formed of an alloy. In some embodiments, electrically conductive tip 186 can be formed of a different material (e.g., carbon (C)).

During use, tip 186 is biased positively (e.g., approximately 20 kV) with respect to extractor 190, extractor 190 is negatively or positively biased (e.g., from −20 kV to +50 kV) with respect to an external ground, and optional suppressor 188 is biased positively or negatively (e.g., from −5 kV to +5 kV) with respect to tip 186. Because tip 186 is formed of an electrically conductive material, the electric field of tip 186 at tip apex 187 points outward from the surface of tip apex 187. Due to the shape of tip 186, the electric field is strongest in the vicinity of tip apex 187. The strength of the electric field of tip 186 can be adjusted, for example, by changing the positive voltage applied to tip 186. With this configuration, un-ionized gas atoms 182 supplied by gas source 110 are ionized and become positively-charged ions in the vicinity of tip apex 187. The positively-charged ions are simultaneously repelled by positively charged tip 186 and attracted by negatively charged extractor 190 such that the positively-charged ions are directed from tip 186 into ion optics 130 as ion beam 192. Suppressor 188 assists in controlling the overall electric field between tip 186 and extractor 190 and, therefore, the trajectories of the positively-charged ions from tip 186 to ion optics 130. In general, the overall electric field between tip 186 and extractor 190 can be adjusted to control the rate at which positively-charged ions are produced at tip apex 187, and the efficiency with which the positively-charged ions are transported from tip 186 to ion optics 130.

In general, ion optics 130 are configured to direct ion beam 192 onto surface 181 of sample 180. Ion optics 130 can, for example, focus, collimate, deflect, accelerate, and/or decelerate ions in beam 192. Ion optics 130 can also allow only a portion of the ions in ion beam 192 to pass through ion optics 130. Generally, ion optics 130 include a variety of electrostatic and other ion optical elements that are configured as desired. By manipulating the electric field strengths of one or more components (e.g., electrostatic deflectors) in ion optics 130, ion beam 192 can be scanned across surface 181 of sample 180. For example, ion optics 130 can include two deflectors that deflect ion beam 192 in two orthogonal directions. The deflectors can have varying electric field strengths such that ion beam 192 is rastered across a region of surface 181.

When ion beam 192 impinges on sample 180, a variety of different types of particles 194 can be produced. These particles include, for example, secondary electrons, Auger electrons, secondary ions, secondary neutral particles, primary neutral particles, scattered ions and photons (e.g., X-ray photons, IR photons, visible photons, UV photons). Detectors 150 and 160 are positioned and configured to each measure one or more different types of particles resulting from the interaction between ion beam 192 and sample 180. As shown in FIG. 19, detector 150 is positioned to detect particles 194 that originate primarily from surface 181 of sample 180, and detector 160 is positioned to detect particles 194 that emerge primarily from surface 183 of sample 180 (e.g., transmitted particles). In general, any number and configuration of detectors can be used in the microscope systems disclosed herein. In some embodiments, multiple detectors are used, and some of the multiple detectors are configured to measure different types of particles. In certain embodiments, the detectors are configured to provide different information about the same type of particle (e.g., energy of a particle, angular distribution of a given particle, total abundance of a given particle). Optionally, combinations of such detector arrangements can be used.

In general, the information measured by the detectors is used to determine information about sample 180. Typically, this information is determined by obtaining one or more images of sample 180. By rastering ion beam 192 across surface 181, pixel-by-pixel information about sample 180 can be obtained in discrete steps. Detectors 150 and/or 160 can be configured to detect one or more different types of particles 194 at each pixel.

The operation of microscope system 100 is typically controlled via electronic control system 170. For example, electronic control system 170 can be configured to control the gas(es) supplied by gas source 110, the temperature of tip 186, the electrical potential of tip 186, the electrical potential of extractor 190, the electrical potential of suppressor 188, the settings of the components of ion optics 130, the position of sample manipulator 140, and/or the location and settings of detectors 150 and 160. Optionally, one or more of these parameters may be manually controlled (e.g., via a user interface integral with electronic control system 170). Additionally or alternatively, electronic control system 170 can be used (e.g., via an electronic processor, such as a computer) to analyze the information collected by detectors 150 and 160 and to provide information about sample 180 (e.g., topography information, material constituent information, crystalline information, voltage contrast information, optical property information, magnetic information), which can optionally be in the form of an image, a graph, a table, a spreadsheet, or the like. Typically, electronic control system 170 includes a user interface that features a display or other kind of output device, an input device, and a storage medium.

In certain embodiments, electronic control system 170 can be configured to control various properties of ion beam 192. For example, control system 170 can control a composition of ion beam 192 by regulating the flow of gases into gas field ion source 120. By adjusting various potentials in ion source 120 and ion optics 130, control system 170 can control other properties of ion beam 192 such as the position of the ion beam on sample 180, and the average energy of the incident ions.

In some embodiments, electronic control system 170 can be configured to control additional devices. For example, electronic control system 170 can be configured to regulate a supply of water molecules delivered to a region surrounding sample 180 and/or in a region of ion beam 192. Alternatively, or additionally, electronic control system 170 can be configured to control heating and/or cooling devices which can be used in the formation and/or removal of ice layers. Further, in certain embodiments, electronic control system 170 can be configured to control one or more additional particle beams in addition to ion beam 192. Additional particle beams can be used for sample imaging and/or sample modification (e.g., etching, milling).

Detectors 150 and 160 are depicted schematically in FIG. 19, with detector 150 positioned to detect particles from surface 181 of sample 180 (the surface on which the ion beam impinges), and detector 160 positioned to detect particles from surface 183 of sample 180. In general, a wide variety of different detectors can be employed in microscope system 200 to detect different particles, and microscope system 200 can typically include any desired number of detectors. The configuration of the various detector(s) can be selected in accordance with particles to be measured and the measurement conditions. In some embodiments, a spectrally resolved detector may be used. Such detectors are capable of detecting particles of different energy and/or wavelength, and resolving the particles based on the energy and/or wavelength of each detected particle.

Detection systems and methods are generally disclosed, for example, in U.S. Patent Application Publication No. US 2007/0158558.

### Computer Hardware and Software

In general, any of the methods (or portions thereof, such as control steps) described above can be implemented in computer hardware or software, or a combination of both. The methods can be implemented in computer programs using standard programming techniques following the methods and figures described herein. Program code is applied to input data to perform the functions described herein and generate output information. The output information is applied to one or more output devices such as a display monitor. Each program may be implemented in a high level procedural or object oriented programming language to communicate with a computer system. However, the programs can be implemented in assembly or machine language, if desired. In any case, the language can be a compiled or interpreted language. Moreover, the program can run on dedicated integrated circuits preprogrammed for that purpose.

Each such computer program is preferably stored on a storage medium or device (e.g., ROM or magnetic diskette) readable by a general or special purpose programmable computer, for configuring and operating the computer when the storage media or device is read by the computer to perform the procedures described herein. The computer program can also reside in cache or main memory during program execution. The methods or portions thereof can also be implemented as a computer-readable storage medium, configured with a computer program, where the storage medium so configured causes a computer to operate in a specific and predefined manner to perform the functions described herein.

### OTHER EMBODIMENTS

In general, reference has been made herein to ice and water layers, and equilibria involving water vapor. However, other substances can also be used, as an alternative to, or in addition to, water, to form the layers/regions and equilibria disclosed herein. Exemplary materials include the following: CO₂, SO₂, CH₄, Xe, Kr, and O₂.

In addition, while embodiments have been described in which an ion source is a He ion source, other types of gas field ion sources can be used. Examples include Ne ion sources, Ar ion sources, Kr ion sources and Xe ion sources.

Other types of ion sources—as an alternative to, or in addition to, gas field ion sources—can also be used. In some embodiments, a liquid metal ion source can be used. An example of a liquid metal ion source is a Ga ion source (e.g., a Ga focused ion beam column).

In certain embodiments, an ion source is used to create ions that impinge on a sample to cause electrons (e.g., secondary electrons) to leave the sample; one or more images can be formed based on the electrons, which can be detected by one or more detectors. More generally, any charged particle source can be used to form charged particles that cause secondary electrons to leave the sample. For example, an electron source, such as a scanning electron microscope may be used.

As shown in FIG. 19, detectors 150 and 160 are typically positioned in a region outside the ion column (e.g., ion optics 130) to detect particles such as secondary electrons that leave the sample. In some embodiments, at least some of the secondary electrons that are detected pass through at least a portion of (e.g., all of) the column used to focus the charged particle beam onto the sample (e.g., ion optics 130). In the case of a gas field ion microscope, this is commonly referred to as the ion column. Because such columns typically include one or more lenses, such detection configurations are often referred to as through-lens detectors. In such embodiments, a combination of the electric field used in the column with a magnetic field created by the magnetic field source can be used to control the trajectory of the electrons of interest to enhance their detection.

A number of embodiments have been described. Nevertheless, it will be understood that various modifications may be made without departing from the spirit and scope of the invention.

What is claimed is:

1. A method, comprising:
exposing a sample comprising a substrate and a layer of ice disposed on the substrate to a charged particle beam, wherein the charged particle beam is configured to convert a portion of the ice layer from a first form to a second form different from the first crystalline form,
wherein:
the first and second forms are different crystalline forms;
the first form is a crystalline form and the second form is an amorphous form;
the first form is an amorphous form and the second form is a crystalline form; or
in the first form at least some crystal grains of the ice layer have a first orientation and in the second form the at least some crystal grains have a second orientation different from the first orientation.

2. The method of claim 1, wherein the charged particle beam is comprises an ion beam.

3. The method of claim 2, wherein the ion beam is generated by a gas field ion source.

4. The method of claim 1, wherein the charged particle beam comprises an electron beam.

5. The method of claim 1, wherein the first and second forms are different crystalline forms.

6. The method of claim 1, wherein the first form is a crystalline form and the second form is an amorphous form.

7. The method of claim 1, wherein the first form is an amorphous form and the second form is a crystalline form.

8. The method of claim 1, wherein in the first form at least some crystal grains of the ice layer have a first orientation and in the second form the at least some crystal grains have a second orientation different from the first orientation.

9. A method, comprising:
disposing a layer of ice on a surface of a sample;
exposing the layer of ice to a charged particle beam, wherein the charged particle beam is configured to remove material from at least some portions of the ice layer to form a patterned ice layer;
depositing one or more additional layers on the patterned ice layer; and
removing the ice layer to produce a pattern of the one or more additional layers disposed on the sample.

10. The method of claim 9, wherein the charged particle beam is comprises an ion beam.

11. The method of claim 10, wherein the ion beam is generated by a gas field ion source.

12. The method of claim 9, wherein the charged particle beam comprises an electron beam.

13. The method of claim 9, depositing the one or more additional layers is performed using an ion beam.

14. The method of claim 13, removing the ice layer is performed using the ion beam.

15. The method of claim 9, removing the ice layer is performed using an ion beam.

16. A method, comprising:
exposing a sample surface to a charged particle beam in the presence of water vapor, wherein the charged particle beam is configured to deposit a layer of ice on the sample surface in the region of the charged particle beam.

17. The method of claim 16, wherein the charged particle beam is comprises an ion beam.

18. The method of claim 17, wherein the ion beam is generated by a gas field ion source.

19. The method of claim 16, wherein the charged particle beam comprises an electron beam.

20. The method of claim 16, wherein the water vapor is near its thermodynamic triple point.
